(19) United States
(12) Patent Application Publication
(10) Pub. No.: US 2013/0266148 A1
(43) Pub. Date: Oct. 10, 2013

(54) Electronic Devices for Reducing Acoustic Leakage Effects and Related Methods and Computer Program Products

(71) Applicant: Peter Isberg, Lund (SE)

(72) Inventor: Peter Isberg, Lund (SE)

(21) Appl. No.: 13/819,461

(22) PCT Filed: May 13, 2011
(86) PCT No.: PCT/IB11/01029

§ 371 Date: Jun. 10, 2013

(51) Int. Cl. H04R 3/04

(52) U.S. Cl. CPC H04R 3/04
USPC 381/58

(57) ABSTRACT

An electronic device includes a housing comprising a speaker configured to be positioned adjacent an ear of a user, and a position-sensitive region on the housing that is configured to sense a position of the ear of the user relative to the housing when the ear is positioned adjacent the speaker and to generate an acoustic leakage position signal responsive to the sensed position of the ear of the user. A control unit is in communication with the speaker and the position-sensitive region and is configured to provide an electrical input signal to the speaker. The control unit is further configured to receive the acoustic leakage position signal and to adapt the electrical input signal responsive to the acoustic leakage position signal.

### FIELD OF THE INVENTION

The present invention relates to mobile communications terminals for reducing acoustic leakage effects.

### BACKGROUND

Mobile communications terminals, such as cellular phones, typically include a speaker on the terminal housing for emitting sound to the user's ear, for example, during a telephone conversation. This mode of operation may be referred to as a “handset mode” when no separate hands-free or headset unit is used.

The sound characteristics as heard by the user's ear may change with the position and application of force to the user's ear, which may cause varying degrees of acoustic leakage. The leak tolerance of the particular mobile communications terminal may be improved by acoustical and/or mechanical designs. However, such designs may require relatively powerful and large transducers with associated disadvantages in terms of size, weight, and/or power consumption for the mobile phone. Moreover, the leakage results in a variation in frequency response such that some frequencies are affected differently than other frequencies. For example, when the acoustic leakage is relatively large, it is generally more difficult for the user to hear low frequencies. Therefore, increasing the volume of the speaker does not adequately address problems with acoustic leakage.

International Publication Number WO 2010/145723 discusses a control unit that is adapted to estimate a transfer characteristic for reducing the effects of acoustic leakage. The transfer characteristic is estimated based on an electrical input signal supplied to an input port of the speaker and an electrical output signal received from an output port of an acoustic sensor. The control unit estimates a degree of sound leakage from the user's ear based on the estimated transfer characteristic.

However, additional techniques for reducing the effects of acoustic leakage are needed.

### SUMMARY OF EMBODIMENTS OF THE INVENTION

In some embodiments, an electronic device includes a housing comprising a speaker configured to be positioned adjacent an ear of a user, and a position-sensitive region on the housing that is configured to sense a position of the ear of the user relative to the housing when the ear is positioned adjacent the speaker and to generate an acoustic leakage position signal responsive to the sensed position of the ear of the user. A control unit is in communication with the speaker and the position-sensitive region and is configured to provide an electrical input signal to the speaker. The control unit is further configured to receive the acoustic leakage position signal and to adapt the electrical input signal responsive to the acoustic leakage position signal.

In some embodiments, the acoustic leakage position signal comprises contact points between the user's ear and the electronic device.

In some embodiments, the acoustic leakage position signal comprises one or more distances between the user's ear and the electronic device.

In some embodiments, the control unit is configured to adapt the electrical input signal responsive to the acoustic leakage position signal by modifying an adjustable filter and applying the adjustable filter to the electrical input signal to the speaker. The adjustable filter may configured to increase a gain of selected acoustic frequencies. The adjustable filter may be configured to increase a gain on lower frequencies relative to higher frequencies. The adjustable filter may be configured to increase a gain for frequencies that are lower than an estimated peak frequency at an amount that is greater than an increase in the gain for frequencies that are higher than the estimated peak frequency. The estimated peak frequency may be between about 1 and 2 kHz. The control unit may be configured to estimate an estimated amount of acoustic leakage responsive to the acoustic leakage position signal and to modify the adjustable filter responsive to the estimated amount of acoustic leakage

In some embodiments, methods for reducing acoustic leakage in an electronic device are provided. The electronic device includes a housing having a speaker configured to be positioned adjacent an ear of a user, a position-sensitive region configured to sense a position of the ear of the user relative to the housing when the ear is positioned adjacent the speaker, and a control unit in communication with the speaker and the position-sensitive region and configured to provide an electrical input signal to the speaker. A position input is received at the position-sensitive region of the electronic device. An acoustic leakage position signal is generated responsive to receiving the position input at the position-sensitive region. The electrical input signal to the speaker is adapted at the control unit responsive to the acoustic leakage position signal.

In some embodiments, the acoustic leakage position signal comprises contact points between the user's ear and the electronic device.

In some embodiments, the acoustic leakage position signal comprises one or more distances between the user's ear and the electronic device.

In some embodiments, the electrical input signal is adapted responsive to the acoustic leakage position signal by modifying an adjustable filter and applying the adjustable filter to the electrical input signal to the speaker. A gain may be modified on selected acoustic frequencies using the adjustable filter. A gain of lower frequencies may be increased relative to higher frequencies using the adjustable filter. A gain for frequencies that are lower than an estimated peak frequency may be increased at an amount that is greater than in the gain for frequencies that are higher than the estimated peak frequency. The estimated peak frequency may be between about 1 and 2 kHz. In some embodiments, an estimated amount of acoustic leakage is estimated responsive to the acoustic leakage position signal and the adjustable filter is modified responsive to the estimated amount of acoustic leakage.

In some embodiments, a computer program product for reducing acoustic leakage of an electronic device is provided. The electronic device includes a housing having a speaker configured to be positioned adjacent an ear of a user, and a position-sensitive region configured to sense a position of the ear of the user relative to the housing when the ear is positioned adjacent the speaker. The computer program product comprises computer readable storage medium having computer readable program code embodied in the medium. The computer readable program code comprises computer readable program code configured to receive a position input at the position-sensitive region of the electronic device; computer readable program code configured to generate an acoustic leakage position signal responsive to receiving the position input at the position-sensitive region; and computer readable program code configured to adapt an electrical input signal to the speaker responsive to the acoustic leakage position signal.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a schematic diagram of a mobile terminal according to some embodiments of the current invention.

FIG. 2A is a side view of a mobile terminal having a position-sensitive region positioned adjacent an ear of the user according to some embodiments of the current invention.

FIG. 2B is a front view of the mobile terminal of FIG. 2A and a position image according to some embodiments of the current invention.

FIG. 3A is a side view of the mobile terminal of FIGS. 2A-2B in another position adjacent the ear of the user according to some embodiments of the current invention.

FIG. 3B is a front view of the mobile terminal of FIG. 3A and a position image corresponding to the position shown in FIG. 3A according to some embodiments of the current invention.

FIG. 4A a side view of the mobile terminal of FIGS. 2A-2B in another position adjacent the ear of the user according to some embodiments of the current invention.

FIG. 4B is a front view of the mobile terminal of FIG. 4A and a position image corresponding to the position shown in FIG. 4A according to some embodiments of the current invention.

FIG. 5 is a graph illustrating exemplary measurements from a Head And Torso Simulator (HATS) including an artificial ear including a frequency dependent magnitude response from an input voltage to a speaker.

FIG. 6 is a flowchart illustrating exemplary operations according to some embodiments of the current invention.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

The present invention is described below with reference to block diagrams and/or flowchart illustrations of methods, apparatus (systems and/or devices) and/or computer program products according to embodiments of the invention. It is understood that a block of the block diagrams and/or flowchart illustrations, and combinations of blocks in the block diagrams and/or flowchart illustrations, can be implemented by hardware and/or in software (including firmware, resident software, micro-code, etc.), referred to herein as “circuitry” or “circuit.” For example, some of the functionality may be implemented in computer program instructions that may be provided to a processor of a general purpose computer, special purpose computer, digital signal processor and/or other programmable data processing apparatus to produce a machine, such that the instructions, which execute via the processor of the computer and/or other programmable data processing apparatus, create means (functionality) and/or structure for implementing the functions/acts specified in the block diagrams and/or flowchart block or blocks.

These computer program instructions may also be stored in a computer-readable memory that can direct a processor of the computer and/or other programmable data processing apparatus to function in a particular manner, such that the instructions stored in the computer-readable memory produce an article of manufacture including instructions which implement the function/act as specified in the block diagrams and/or flowchart block or blocks. The computer program instructions may also be loaded onto a computer and/or other programmable data processing apparatus to cause a series of operational steps to be performed on the computer and/or other programmable apparatus to produce a computer-implemented process such that the instructions which execute on the computer or other programmable apparatus provide steps for implementing the functions/acts specified in the block diagrams and/or flowchart block or blocks.

A computer-usable or computer-readable medium may be, for example but not limited to, an electronic, magnetic, optical, electromagnetic or semiconductor system, apparatus or device. More specific examples (a non-exhaustive list) of the computer-readable medium would include the following: a portable computer diskette, a random access memory (RAM), a read-only memory (ROM), an erasable programmable read-only memory (EPROM or Flash memory), and a portable optical and/or magnetic media, such as a flash disk or CD-ROM.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated. Although some of the diagrams include arrows on communication paths to show a primary direction of communication, it is to be understood that communication may occur in the opposite direction to the depicted arrows.

For purposes of illustration and explanation only, various embodiments of the present invention are described herein primarily in the context of mobile terminals including touchscreen displays; however, it will be understood that the present invention is not limited to such embodiments and may be embodied generally in any system that employs a touch-sensitive or position-sensitive region, such as a headset, headphones, or other electronic devices that employ speakers held adjacent the ear. As used herein, a “position-sensitive region” may refer to a region of a terminal having sensors that are suitable for identifying a position, for example, of a user's ear, including pressure or touch-sensitive sensors and sensors that can sense an object proximate the sensor, such as infrared detectors that may be used to detect a distance of the user's ear from the speaker and/or phone. A position-sensitive region may or may not provide a user interface, such as an electronic input device (e.g., a touchscreen), that is configured to detect touch and/or motion-based user inputs on an area within which the sensor is bounded. A touchscreen may include sensors that are configured to sense a distance between the screen and an object that is placed adjacent the screen. Exemplary position-sensitive regions of the mobile terminal include capacitance-based touch-sensitive interfaces, resistance, surface acoustic wave (SAW), infrared, strain gauge, optical imaging, dispersive signal, acoustic pulse imaging, frustrated total internal reflection, and/or other touch or distance/position sensing technologies. Exemplary position-sensitive devices including electromagnetic radiation emitter (such as infrared emitters) that are configured to detect a distance between an object and the emitter are described, for example, in U.S. application Ser. No. 12/899,037, filed Oct. 6, 2010, the disclosure of which is hereby incorporated by reference in its entirety. It should be understood that such position-sensitive devices may be incorporated into a touchscreen or positioned in any suitable location of the device such as the housing. As used herein, the term “touchscreen” or “touch-sensitive” device includes devices that are configured to detect physical touches as well as distances between the device and another non-contacting object adjacent the sensors.

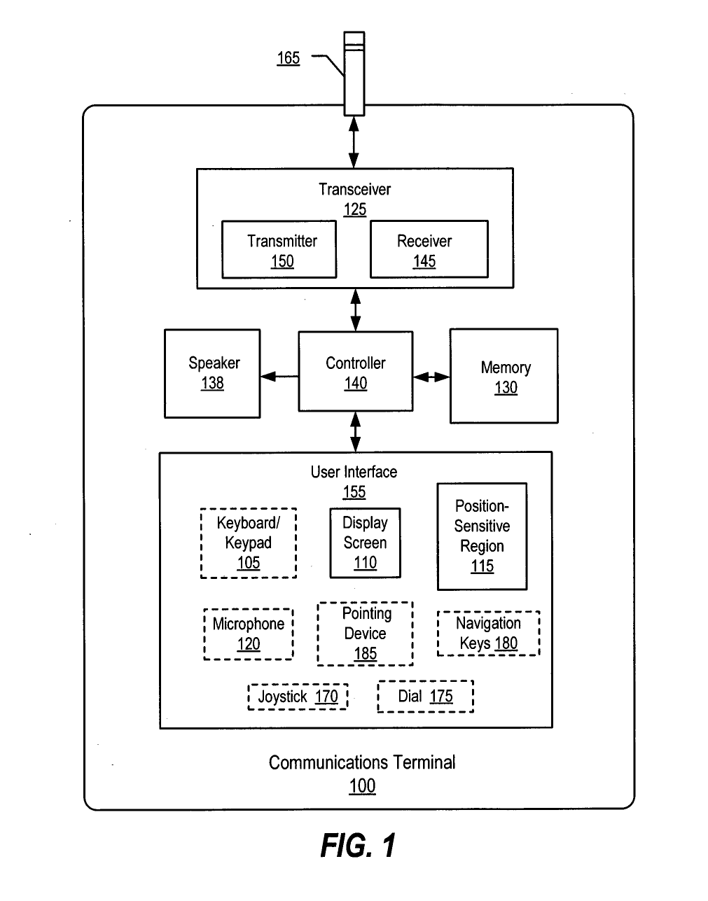

FIG. 1 is a block diagram illustrating an electronic device with a position-sensitive region in accordance with some embodiments of the present invention. As shown in FIG. 1, an exemplary electronic device 100 includes a transceiver 125, memory 130, a speaker 138, a processor 140, and a user interface 155. The transceiver 125 typically includes a transmitter circuit 150 and a receiver circuit 145 that cooperate to transmit and receive radio frequency signals to and from base station transceivers via an antenna 165. The radio frequency signals transmitted between the electronic device 100 and the base station transceivers may include both traffic and control signals (e.g., paging signals/messages for incoming calls), which are used to establish and maintain communication with another party or destination. The radio frequency signals may also include packet data information, such as, for example, cellular digital packet data (CDPD) information. In addition, the transceiver 125 may include an infrared (IR), Bluetooth, and/or Wi-Fi transceiver configured to transmit/receive signals to/from other electronic devices.

The memory 130 may represent a hierarchy of memory that may include volatile and/or non-volatile memory, such as removable flash, magnetic, and/or optical rewritable non-volatile memory. The memory 130 may be configured to store several categories of software, such as an operating system, applications programs, and input/output (I/O) device drivers. The operating system may control the management and/or operation of system resources and may coordinate execution of programs by the processor 140. The I/O device drivers typically include software routines accessed through the operating system by the application programs to communicate with input/output devices, such as those included in the user interface 155 and/or other components of the memory 130.

The processor 140 is coupled to the transceiver 125, the memory 130, the speaker 138, and the user interface 155. The processor 140 may be, for example, a commercially available or custom microprocessor that is configured to coordinate and manage operations of the transceiver 125, the memory 130, the speaker 138, and/or the user interface 155.

The user interface 155 may include a microphone 120, a display screen 110 (such as a liquid crystal display), a position-sensitive region 115, a joystick 170, a keyboard/keypad 105, a dial 175, directional navigation key(s) 180, and/or a pointing device 185 (such as a mouse, trackball, etc.). However, depending on functionalities offered by the electronic device 100, additional and/or fewer elements of the user interface 155 may actually be provided. For instance, the position-sensitive region 115 may be implemented as an overlay on the display screen 110 to provide a touch-sensitive display screen (or “touch screen”) in some embodiments. More generally, while particular functionalities are shown in particular blocks by way of illustration, functionalities of different blocks and/or portions thereof may be combined, divided, and/or eliminated.

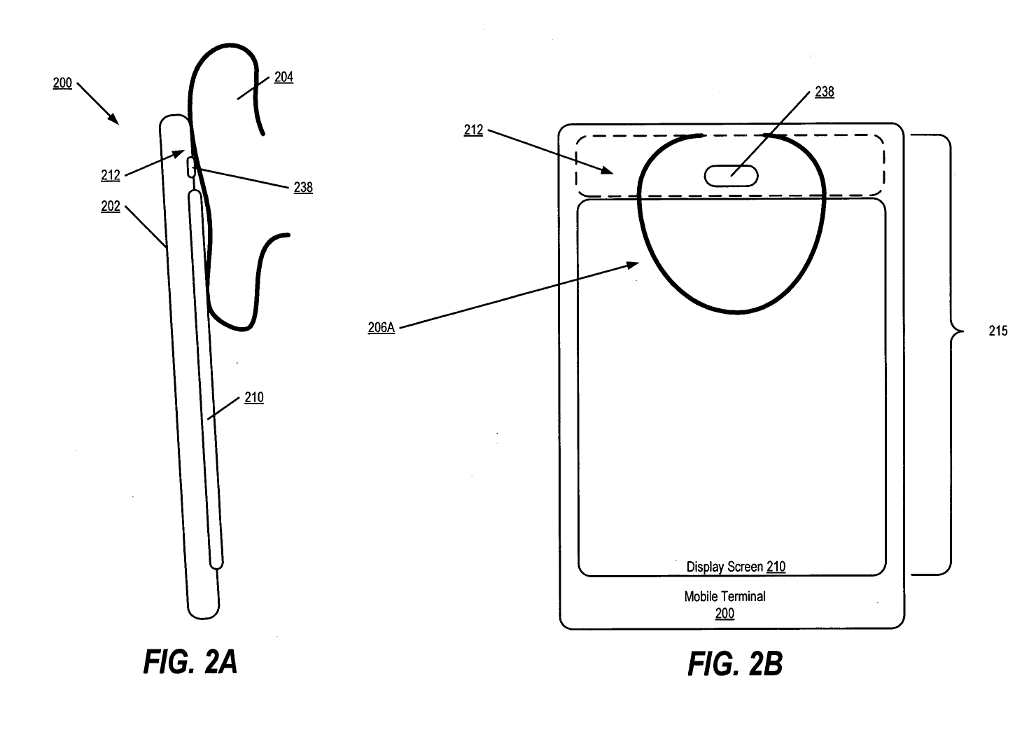

As shown in FIGS. 2A-2B, the mobile terminal 200 includes a housing 202 having a display screen 210 and a speaker 238 thereon. The display screen 210 may be a touch-sensitive display screen that provides a first position-sensitive region. The housing 202 further includes a second position-sensitive region 212 that together may form a combined position-sensitive region 215.

As illustrated, a user's ear 204 is positioned adjacent the speaker 238 during use. As used herein, the term “speaker” may include the speaker output or earpiece including a duct, vibration panels or other acoustic conduit that transmits the acoustic signal to a position on the phone. For example, the speaker 238 may include speaker electronics positioned, for example, beneath the display 210 with a duct and/or vibration panels that make the sound reproducible on an exterior portion of the phone.

The position-sensitive region 215 is configured to sense a position of the ear of the user relative to the housing when the ear is positioned adjacent the speaker 238 and to generate a position signal responsive to the sensed position of the user's ear as indicated by the image 206A. The image 206A is shown in FIG. 2B for illustrative purposes; however, it should be understood that the image 206A may not necessarily appear on the screen 210 or region 212 and indicates that the ear 204 forms a generally ring-shaped contact on the position-sensitive region 215 around the speaker 238.

As illustrated in FIG. 1, the controller 140 is configured to provide an electrical input signal to the speaker 138. The electrical input signal causes the speaker to emit sound, for example, from a telephone or communication connection or other audio source. The controller 140 is further configured to receive the position signal from the position-sensitive region 215 (as represented by the position image 206A) and to adapt the electrical input signal to the speaker 238 responsive to the position signal. The position signal may include data relevant to estimating an amount or quality of acoustic leakage such as information regarding the position or shape of the user's ear, including the points that the ear contacts the mobile terminal 200 and/or a distance between the ear 204 and the mobile terminal 200. Thus, the position signal may represent data that is two-dimensional (e.g., contact positions between the ear 204 and the terminal 200) or three-dimensional (e.g., distances and contact points between the ear 204 and the terminal 200, such as a three-dimensional distance profile).

Accordingly, the controller 140 may utilize the position signal or sense image 206A to estimate a degree or quality of the acoustic leakage due to the position of the user's ear relative to the speaker 238 and housing 202 of the mobile communications terminal 200. When the ear 204 is positioned in generally close contact with the position-sensitive region 215 as shown in FIGS. 2A-2B, a generally low degree of acoustic leakage is likely occurring.

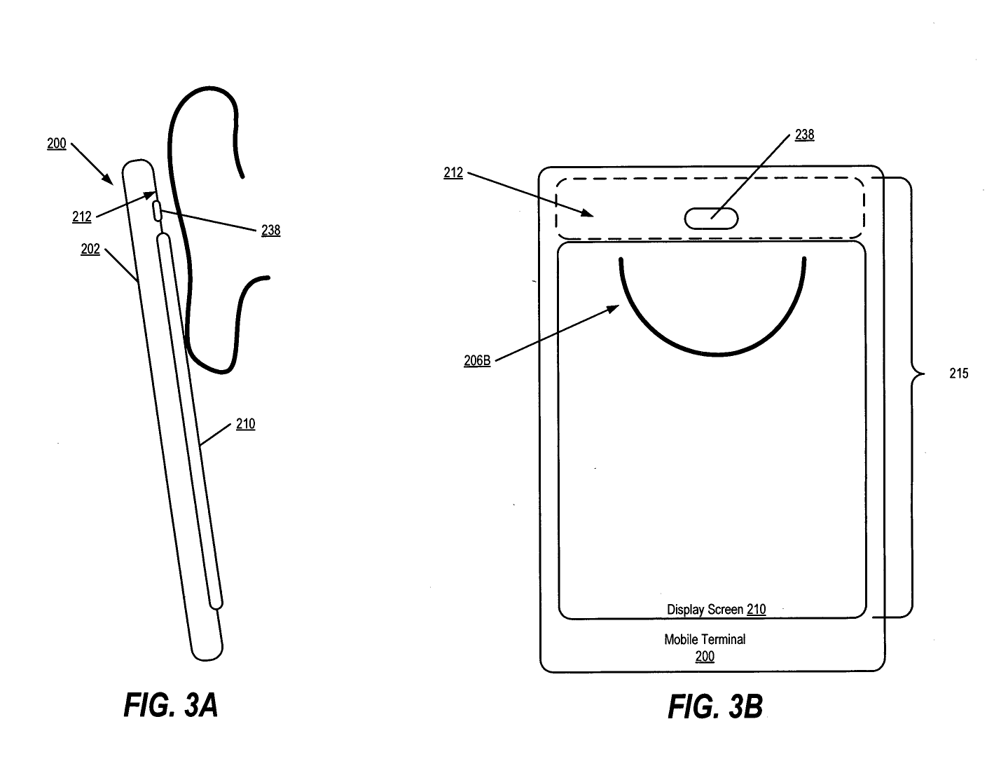

In contrast, as illustrated in FIGS. 3A-3B, the user's ear 204 is positioned so that the top portion of the ear 204 is not in contact with the position-sensitive region 212 as indicated by the image 206B. The detected contact points indicated by the image 206B indicate that a generally high level of acoustic leakage is likely occurring.

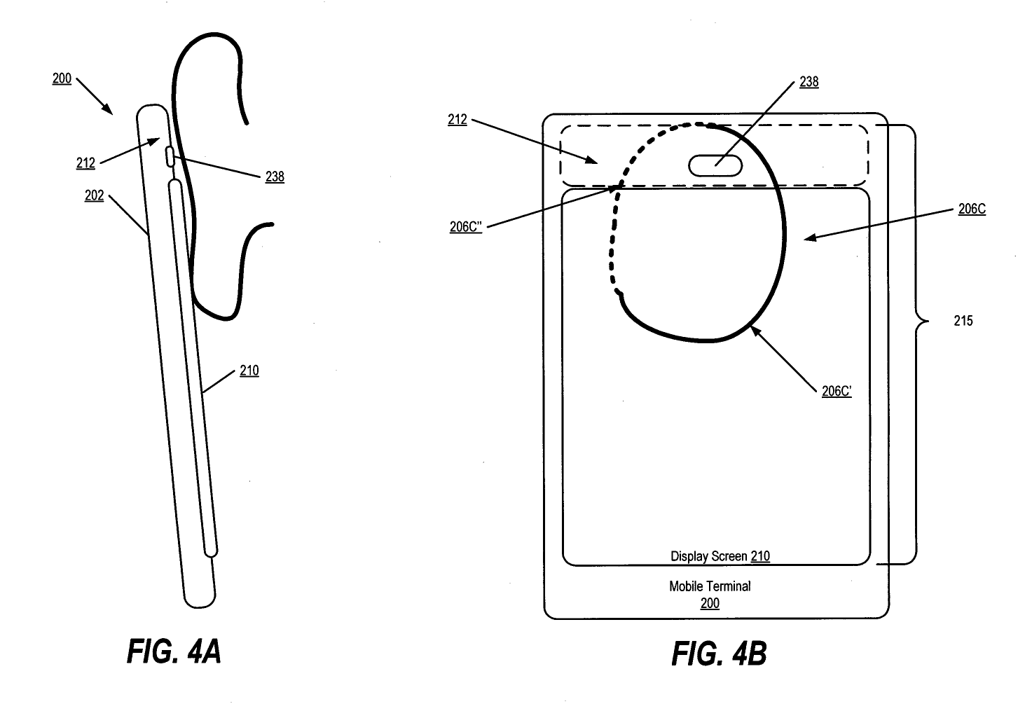

Although in the embodiments described with respect to FIGS. 2A-2B and FIGS. 3A-3B, the acoustic leakage may be estimated based on the images 206A and 206B that indicate where the ear 204 is in contact with the position-sensitive region 215, it should be understood that the acoustic leakage may be estimated based on a distance between the ear 204, and the terminal 200 when at least a portion of the ear 204 is not in contact with the terminal 200. For example, as illustrated in FIG. 4B, the ear 204 provides input to the position-sensitive region 215 as illustrated by the image 206C. The image 206C includes a portion 206C′ (indicated by a solid line) that is in general contact with the position-sensitive region 215 and another portion 206C″ (indicated by a broken line) that is spaced apart from the position-sensitive region 215. Accordingly, in some embodiments, a generally three-dimensional image of the ear 204 may be used to generate an estimation of the position of the ear 204 and a corresponding amount or quality of acoustic leakage.

As discussed above with respect to FIG. 1, the controller 140 may adapt the electrical input signal to the speaker 138 responsive to a position signal generated by the position-sensitive region 215. The degree and/or quality of leakage of sound from the ear 204 may result in sound that is perceived differently by the user depending on the position of the ear 204 with respect to the speaker 238 and the housing 202. Typically, acoustic leakage effects or frequencies to a larger extent and higher frequencies so that for a larger degree of leakage, there is normally a larger degree of attenuation at lower frequencies than at higher frequencies as perceived by the user. In some embodiments, the controller 140 may apply an adjustable filter for adapting electrical input signal to the speaker 138. The adjustable filter may be configured to filter the input signal so that the resulting filtered signal is supplied to the speaker 138. The control unit 140 adjusts the adjustable filter responsive to an estimated degree and/or quality of acoustic leakage to compensate for the position of the ear 204. That is, different frequencies may be affected or attenuated differently due to a given position of the ear 204, and the adjustable filter may be modified or adjusted to counteract this effect so that the acoustic leakage of the overall quality and characteristics of the sound perceived by the user is reduced or eliminated. The adjustable filter may be determined responsive to measurements for a particular mobile terminal shapes and/or speaker having corresponding acoustic properties.

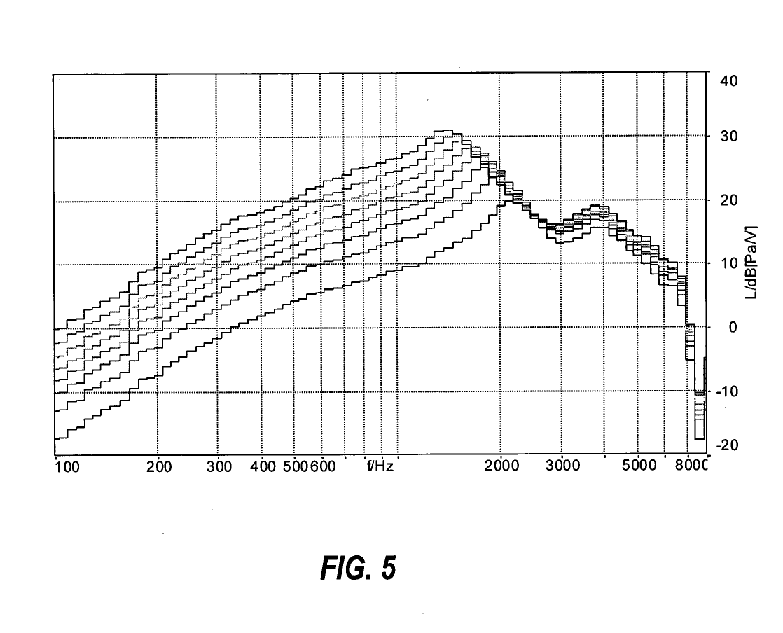

For example, as illustrated in FIG. 5, a Head And Torso Simulator (HATS) including an artificial ear was used to measure a frequency dependent magnitude response from an input voltage to a speaker. A HATS Type 4128C from Brüel & Kjaer Sound & Vibration Measurements A/S (Naerum, Denmark) was used; however, any suitable artificial ear or HATS configuration may be used. As illustrated, the larger the acoustic leakage, the more low-frequency output is reduced. In addition, a peak in the responses observed, typically about 1 to 2 kHz. The larger the acoustic leakage, the higher the frequency of the response peak. In some embodiments, the controller 140 may estimate the frequency of the response peak and modify the adjustable speaker in response to an estimated response peak.

Accordingly, the controller 140 may apply a filter to the electrical input signal of the speaker 138 that increases the amplification or gain more for lower frequencies than for higher frequencies, e.g., in accordance with HATS or other artificial ear measurements and corresponding mobile terminal positions.

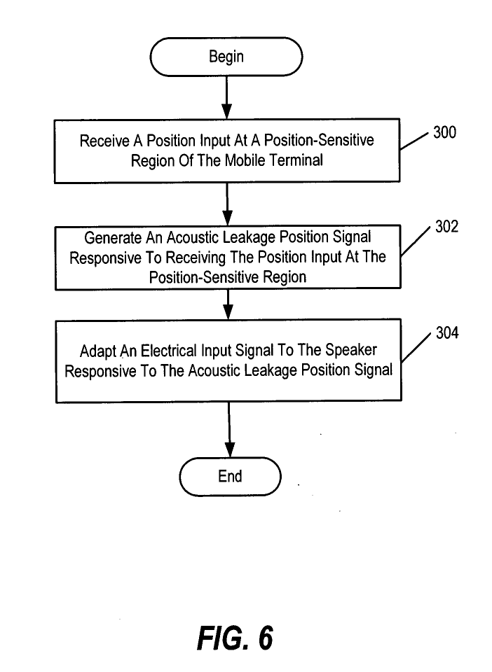

As illustrated in FIG. 6, a position input is received at a position-sensitive region of the mobile terminal (Block 300) and a position signal is generated that corresponds to the position input at the position-sensitive region of the mobile terminal (Block 302). A control unit (such as the controller 140 in FIG. 1) adapts an electrical input signal to the speaker of the mobile terminal responsive to the position signal (Block 304). For example, the control unit may apply a filter to the electrical input signal that may include a frequency dependent adjustment in the gain or amplification, which in some embodiments increases the gain of the lower frequencies relative to the upper frequencies. Exemplary filters based on a degree of acoustic leakage are discussed in International Patent Application Publication Number WO 2010/145723, the disclosure of which is hereby incorporated by reference in its entirety.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. An electronic device comprising:
a housing comprising a speaker configured to be positioned adjacent an ear of a user, and a position-sensitive region on the housing that is configured to sense a position of the ear of the user relative to the housing when the ear is positioned adjacent the speaker and to generate an acoustic leakage position signal responsive to the sensed position of the ear of the user; and
a control unit in communication with the speaker and the position-sensitive region that is configured to provide an electrical input signal to the speaker, wherein the control unit is further configured to receive the acoustic leakage position signal and to adapt the electrical input signal responsive to the acoustic leakage position signal.

2. The electronic device of claim 1, wherein the acoustic leakage position signal comprises contact points between the user's ear and the electronic device.

3. The electronic device of claim 2, wherein the acoustic leakage position signal comprises one or more distances between the user's ear and the electronic device.

4. The electronic device of claim 1, wherein the control unit is configured to adapt the electrical input signal responsive to the acoustic leakage position signal by modifying an adjustable filter and applying the adjustable filter to the electrical input signal to the speaker.

5. The electronic device of claim 4, wherein the adjustable filter is configured to increase a gain for selected acoustic frequencies.

6. The electronic device of claim 5, wherein the adjustable filter is configured to increase a gain for lower frequencies relative to higher frequencies.

7. The electronic device of claim 5, wherein the adjustable filter is configured to increase a gain for frequencies that are lower than an estimated peak frequency at an amount that is greater than an increase in the gain for frequencies that are higher than the estimated peak frequency.

8. The electronic device of claim 7, wherein the estimated peak frequency is between about 1 and 2 kHz.

9. The electronic device of claim 8, wherein the control unit is configured to estimate an estimated amount of acoustic leakage responsive to the acoustic leakage position signal and modify the adjustable filter responsive to the estimated amount of acoustic leakage.

10. A method for reducing acoustic leakage in an electronic device, the electronic device comprising a housing having a speaker configured to be positioned adjacent an ear of a user, a position-sensitive region configured to sense a position of the ear of the user relative to the housing when the ear is positioned adjacent the speaker, and a control unit in communication with the speaker and the position-sensitive region and configured to provide an electrical input signal to the speaker, the method comprising:
receiving a position input at the position-sensitive region of the electronic device;
generating an acoustic leakage position signal responsive to receiving the position input at the position-sensitive region; and
adapting the electrical input signal to the speaker at the control unit responsive to the acoustic leakage position signal.

11. The method of claim 10, wherein the acoustic leakage position signal comprises contact points between the user's ear and the electronic device.

12. The method of claim 11, wherein the acoustic leakage position signal comprises one or more distances between the user's ear and the electronic device.

13. The method of claim 11, further comprising adapting the electrical input signal responsive to the acoustic leakage position signal by modifying an adjustable filter and applying the adjustable filter to the electrical input signal to the speaker.

14. The method of claim 13, further comprising increasing a gain for selected acoustic frequencies using the adjustable filter.

15. The method of claim 14, further comprising increasing a gain for lower frequencies relative to higher frequencies using the adjustable filter.

16. The method of claim 14, further comprising increasing a gain for frequencies that are lower than an estimated peak frequency at an amount that is greater than in the gain for frequencies that are higher than the estimated peak frequency.

17. The method of claim 16, wherein the estimated peak frequency is between about 1 and 2 kHz.

18. The method of claim 17, further comprising estimating an amount of acoustic leakage responsive to the acoustic leakage position signal and modifying the adjustable filter responsive to the estimated amount of acoustic leakage.

19. A computer program product for reducing acoustic leakage of an electronic device, the electronic device comprising a housing having a speaker configured to be positioned adjacent an ear of a user, and a position-sensitive region configured to sense a position of the ear of the user relative to the housing when the ear is positioned adjacent the speaker, the computer program product comprising:
computer readable storage medium having computer readable program code embodied in said medium, the computer readable program code comprising:
computer readable program code configured to receive a position input at the position-sensitive region of the electronic device;
computer readable program code configured to generate an acoustic leakage position signal responsive to receiving the position input at the position-sensitive region; and
computer readable program code configured to adapt an electrical input signal to the speaker responsive to the acoustic leakage position signal.
